(19) United States
(12) Patent Application Publication
(10) Pub. No.: US 2010/0237242 A1
(43) Pub. Date: Sep. 23, 2010

(54) DEVICE AND METHOD FOR CRYSTAL ORIENTATION MEASUREMENT BY MEANS OF AN ION BLOCKING PATTERN AND A FOCUSED ION PROBE

(76) Inventor: Robert Schwarzer, Herrenberg (DE)

Correspondence Address: DAVID A. GUERRA;INTERNATIONAL PATENT GROUP, LLC, Suite 700, 1816 Crowchild Trail N.W., CALGARY, AB, T2M 3Y7, CA

(21) Appl. No.: 12/738,347

(22) PCT Filed: Oct. 29, 2008
(86) PCT No.: PCT/EP08/64670

§ 371 Date: Apr. 16, 2010

(30) Foreign Application Priority Data
Nov. 2, 2007 (DE) 10 2007 052 794.4
Oct. 29, 2008 (EP) PCT/EP2008/064670

(51) Int. Cl. G21K 7/00

(52) U.S. Cl. 250/309

(57) ABSTRACT

The invention relates to a device for crystal orientation measurement, comprising an ion source (42); means (44) for focusing ions emitted from the ion source into an ion probe; and means (18) for receiving a crystalline or multicrystalline sample (16), characterized by an imaging ion detector (12) for registering at least one ion blocking pattern (26) in digital form. The invention further relates to the use of a device according to one of the preceding claims for crystal orientation measurement. The invention further relates to a method for crystal orientation measurement, comprising the focusing of ions emitted from an ion source (42) into an ion probe; directing the ion probe onto a crystalline or multicrystalline sample (16); and registering at least one ion blocking pattern (26) in digital form with the aid of an imaging ion detector (12).

The invention relates to a device for crystal orientation measurement by means of an ion blocking pattern and a focused ion probe according to claims 1 and 11. The device enables the effective, fully automated and fast collection of the distribution of grain orientations and phases in polycrystalline surfaces of solids down to the nanometer range. Fields of application are material sciences, geology and crystallography with issues of texture analysis, recrystallization and grain growth at high spatial resolution and surface sensitivity.

Crystal texture, i.e. the spatial and statistical distribution of the crystallographic orientation of grains in a polycrystal [H. J. Bunge: Texture Analysis in Materials Science—Mathematical Methods. Butterworths, London 1982] is a principal parameter of microstructure, besides micromorphology, phase distribution and element distribution. The description of crystal texture as statistical parameter of the microstructure and the graphical representation of the orientation distribution in form of microstructure images (“Orientation Microscopy”, “Orientation Maps”) requires the knowledge of a very large number of measured individual orientations. Since, however, already the unambiguous determination of a single orientation may be very time consuming, a fully automatic, computer controlled device for measurement and evaluation is required which in addition must enable a high spatial resolution in order to allow for the investigation of fine crystalline solids.

The available techniques of today are based on scanning systems and the diffraction of fine collimated X-ray, synchrotron or electron beams. Most frequently applied is selected area electron diffraction and microbeam diffraction on thin specimens in the transmission electron microscope (ring patterns, texture patterns and Kikuchi patterns) and in particular backscattered electron diffraction (EBSD: Electron Backscatter Diffraction) on bulk specimens by means of backscatter Kikuchi patterns in the scanning electron microscope.

The automated measurement of grain orientations in the scanning electron microscope has developed into an accepted technique in materials science [A. J. Schwartz, M. Kumar and B. L. Adams: Electron Backscatter Diffraction in Materials Science. Kluwer Academic/Plenum Press 2000. ISBN 0-306-46487-X]. Major drawbacks of the EBSD technique are low contrast in backscatter Kikuchi patterns of a few percent, limited spatial and depth resolutions resulting from the size of the interaction volume of high-energy electrons with matter, the necessary specimen tilt of typically 70° with respect to the primary beam owing to pronounced forward scattering of high-energy electrons and hence a pronounced asymmetric aspect ratio of the electron probe on the tilted specimen surface and reduction of spatial resolution in primary beam direction as well as the distortion of the crystal orientation map (COM) of the surface microstructure that is constructed from the orientation data.

As an alternative, grain orientations can be studied by means of the ion blocking effect. When a crystalline specimen is scanned in a scanning ion microscope, the height of the signal in an image point does not only depend on the viewed location on the specimen, but as well from the angle of incidence of the ion beam with respect to the crystal lattice in this location. This results in a pronounced orientation contrast in the microstructure image of a polycrystalline specimen. This is a major application of scanning ion microscopes in materials science. The reason of the anisotropy of the image signal is the ion blocking effect. Electrons—which are released from the crystal when hit by the primary ion beam—are predominantly used as image signal, but also are used backscattered ions, secondary ions, neutral particles, and a signal composed of these particles as well as the ion current absorbed in the sample (probe current signal).

The primary ions penetrate extra deep in the crystallite if they impinge along low indexed crystallographic directions or lattice planes at an angle smaller than a critical angle. In these so-called channeling directions the yield (i.e. the number) of ion-released electrons, backscattered ions, secondary ions and neutral particles per incident primary ion is particularly low. Hence the image signal is lower, and so the corresponding image point in the scanned image appears dark. For directions of incidence at angles with respect to the crystal lattice larger than the critical angle, the range of penetration of primary ions is low; they are “blocked”. Therefore, more ion-released electrons, backscattered ions, secondary ions and neutral particles are emitted from the crystal surface. The higher image signal in blocking directions results in bright pixels in the scanned image. If the microstructure image is recorded by means of the signal of absorbed ion current in the sample, contrast relations are reversed. The critical angles can be computed with classical ballistic theories of ion scattering or with the dynamic theory of ion diffraction.

Orientation contrast in the microstructure image represents the orientation distribution of the crystallites more or less qualitatively. A conclusion on the individual grain orientation or misorientations cannot be drawn, since grains of different orientations may have the same value of anisotropy for the respective direction of incidence and hence are displayed in the image with the same gray tone.

Ion blocking patterns (IBP) [A. F. Tulinov: Influence of the crystal lattice on some atomic and nuclear processes. Soviet Physics USPEKHI 5 (1966) 864-872 (Engl. translation of Usp. Fiz. Nauk 87 (1965) 585-589); R. G. Livesey: A 30 keV instrument for ion surface interactions studies. Vacuum 22 (1972) 595-597] are produced when a fairly parallel ion beam is impinging on a crystalline solid. They show narrow linear bands and have been recorded with special photo plates. They can be interpreted as a result of ion blocking according to a classical ballistic theory of ion scattering or as ion diffraction patterns. Because wavelength of ions is shorter their interaction with the crystalline solid is different as compared to those of electrons, they differ significantly from backscatter Kikuchi patterns.

Crystal structure and grain orientation of individual crystallites can be determined from the intensity and location of bands in the ion blocking pattern. The center lines of bands represent the diffracting families of lattice planes; the points of intersection of bands, named poles, represent zone axes of the crystal.

In literature so far only single crystals or very coarse-grained solids have been investigated by means of ion blocking patterns. If the ion probe, however, is made very small and a narrow aperture is set, ion blocking patterns are produced as well whereby spatial resolution is essentially only limited by the diameter of the probe. In order to prevent from overlaying ion blocking patterns from layers of different orientations, the diameter of the ion probe must in principle be smaller than the size of the crystallites in the polycrystalline solid under investigation.

Fine-collimated ion probes are state of the art. Gas discharges, field emission ion sources and liquid metal ion sources (LMIS) come into consideration as sources [V. N. Tondare: J. Vac. Sci. Techn. A 23 (2005) 1498-1508]. They are commercially used in ion scanning microscopes [ORION Helium Ion Microscope of Carl Zeiss SMT company; J. Morgan and J. Notte: An introduction to the Helium ion microscope. Materials Today 14 (2006) 24-31] as well as attachments (“FIB”) to electron scanning microscopes.

Scanning electron microscopes and scanning ion microscopes are based on a similar principle of forming microstructure images of solid surfaces. They mainly differ in the kind of used primary radiation (electrons respectively ions), the type of lenses and deflection units as well as in the employed detectors. If in the scanning ion microscope only the ion-released electrons serve as image-forming signal, the same detectors as in the scanning electron microscope can be used in imaging mode.

Backscatter Kikuchi patterns are in some aspects related with ion blocking patterns. Both can yield information about the crystal lattice. EBSD systems are state of the art today, however they are not suited for grain orientation measurement by means of ion blocking patterns for several reasons.

Detectors (fluorescence phosphor screens with coupled video cameras) which are used to automatically record backscatter Kikuchi patterns are not suited for recording ion blocking patterns. The phosphor in the fluorescence screen is damaged by the impact of ions forming the pattern as well as by high-energy backscattered ions and neutrals that do not bear information about the crystal lattice. In addition, further signals—which might produce a strong background on the pattern and significantly hamper evaluation—are superimposed on the backscattered ions forming the ion blocking pattern. These signals are mainly composed of ion-released electrons and neutral particles. They must be kept away from the imaging ion detector. In case of Kikuchi patterns, by contrast, not a composite signal is present, but only high-energy backscattered electrons that can excite rather than damage the phosphor screen. (Against the background of isotropically backscattered electrons special image processing methods are applied in EBSD systems.)

In the work of S. Shimoda's and T. Kobayashi's group, microchannel plates are used in the high-energy accelerator for chopping the signals in time-of-flight measurements. The microchannel plates are therefore placed far apart—in contrast to the embodiment of this invention. Only ions can pass that have a definitive speed (i.e. mass respectively kinetic energy). Charge transfer effects after the ions having entered the TOF spectrometer do not adversely affect evaluation. Other ions, neutral particles or electrons do not get at the exit of the detector. If the very primary beam is chopped in a TOF setup, a single microchannel plate is sufficient as “gate”. The purpose of this TOF apparatus is not the determination of grain orientations or texture data, but phase analysis (i.e. the determination of the crystal structure) as a function of depth beneath the specimen surface. Spatial resolution is here of secondary importance.

In the article of J. Saarilhati and E. Rauhale [Interactive personal-computer data analysis of ion backscattering spectra. Nucl. Inst. Meth. Phys. Res. B64 (1992) 734-738] microchannel plates are not used to record ion blocking patterns, but to record energy spectra of backscattered ions. From these spectra the element distribution (composition), also at depth resolution beneath the surface, is determined interactively with a computer program.

Ion blocking patterns are distinguished from backscatter Kikuchi patterns—that are known from electron diffraction in the scanning electron microscope—by significant features. The reasons are different mechanisms of generation (classical ballistic ion scattering versus electron diffraction), as well as the different species (mass, charge, wavelength of the particles) and different interaction with the crystal lattice.

In detail the following differences are between ion blocking patterns and backscatter Kikuchi patterns. Background has a different structure; the intensity gradient in ion blocking patterns is smoother. The band profile of ion blocking patterns is bell-shaped, whereas bands in Kikuchi patterns for the most part show a pronounced, for all diffracting families of lattice planes significant structure. The width of Kikuchi bands is very precisely described by Bragg's equation; for ion blocking patterns, on the contrary, a sufficiently precise theory is missing so that the band widths (critical angle) cannot be used for indexing. Kikuchi bands are bordered by sharp Kikuchi lines at the position of the Bragg angle, a fact that facilitates evaluation; as contrasted, analogous lines are missing in ion blocking patterns. In Kikuchi patterns higher orders of diffractions appear in particular at low indexed bands which can be used for precise indexing; they are missing in ion blocking patterns. Finally, ion blocking patterns show pronounced, almost round minima (patches) around low-index zone axes that often have a greater diameter than is the width of the crossing bands; such “patches” are missing in Kikuchi patterns.

Programs as developed for the localization and indexing of bands of Kikuchi patterns are therefore not suited for application to ion blocking patterns. Allowance has to be made for the specific features of ion blocking patterns.

An issue of the present invention is to describe a device and technique that enable a computer-based measurement of grain orientations by means of ion blocking patterns. In the invention the task is solved by means of a device with the features of claim 1 or by means of a technique with the features of claim 11.

By utilizing a focused ion probe in the device and technique conforming the invention, the problem is solved that spatial resolution of those techniques for texture measurement that are available at present are not sufficient to study fine-grained (nano-)materials. A significant advantage of the device conforming the invention is a high spatial resolution. Spatial resolution of devices that are based on X-ray or synchrotron diffraction is today about a few micrometer respectively some tenth of a micrometer. With the transmission electron microscope individual grain orientations in thin foils can be determined in selected area diffraction mode (SAD) at about 0.5 μm and in microbeam diffraction mode (transmission Kikuchi patterns) down to about 10 nm. Spatial resolution achievable with backscatter Kikuchi patterns from solid specimen surfaces in the scanning electron microscope is limited to the range of the interaction volume of electrons in solids at some 10 nm, depending on the accelerating voltage and the density of the sample material, whereas ion blocking patterns are produced in the utmost atomic layers of the crystal. As a consequence, the achievable spatial resolution is in the latter case limited by the diameter of the ion probe. It is safe to assume a spatial resolution down to the sub-nanometer range by using ion blocking patterns, according to the spatial resolution that has already been achieved with the He ion scanning microscope in imaging mode of operation. The technique of measurement with ion blocking patterns is furthermore surface sensitive.

Ions suitable for generating ion blocking patterns are for instance H⁺, He⁺, Ne⁺, Ar⁺, but as well positive or negative ions of high atomic weight such as Ga⁺ and In⁺, or a mixture of ionized air. The energy E is preferentially in the keV range at a width of ΔE/E<10-2. The scattering characteristics of ions in the keV range does not show a pronounced forward direction so that the specimen needs to be tilted with respect to the primary beam only so far that a sufficiently large area of the diffraction pattern is collected by the detector. The moderate specimen tilt reduces the aspect ratio of the ion probe on the tilted specimen surface as well as the distortion of the orientation distribution map of the surface microstructure that is reconstructed from the orientation data.

By comprising an imaging ion detector for recording at least one ion blocking pattern in digital form, the device according to the invention enables a computer-based measurement of grain orientations. By this means the problem is solved that the interactive positioning of the ion probe, the recording of individual ion blocking patterns, the interactive localization of the bands or poles as well as the manual evaluation by the operator are time-consuming and susceptible to error. This approach is not practical for texture analysis because a very large number of individual orientations are required.

The device may be constructed such that the ion probe is directed onto a selected location of the specimen. Alternatively or in combination with that, the device is preferentially constructed that the ion probe is directed successively on a great number of selected locations of the specimen and so record by means of the imaging ion detector an ion blocking pattern in digital form at each of the selected locations. By this means, a measurement of the grain orientation is enabled at a great number of selected locations.

Particularly preferred is that the device is embodied to scan the specimen point by point with the ion probe. By this means the problem is solved that for the characterization of the microstructure the statistical evaluation and analysis of the crystal texture a very large number of measured values is required in a field of regular scanning points, and that this cannot be accomplished by an interactive positioning of the beam by the operator. Therefore, the specimen surface is fully automatically scanned point by point in the presented device, either by a mechanical translation of the specimen in an x-y stage with respect to the stationary ion probe, or by deflecting the ion beam with respect to the stationary probe, or by a combination of translating the probe and deflecting the ion beam. In addition to the fully automatic scan of a specimen area by means of a control device, selected locations on the specimen can still be driven at by the operator as an option.

The device can comprise means for interactive representation of a digitally recorded ion blocking pattern so enabling the operator to detect and locate the bands in the ion blocking pattern. By this means the problem is solved that for the calibration of the system band and/or pole positions have to be located with highest accuracy, that “wrong” (=not really existing) bands or poles are automatically detected or existing bands respectively poles—that are important for indexing—are not automatically detected and/or that in few instances automatic detection fails at all. The localization of bands and/or poles in ion blocking patterns can thus be carried out interactively by the operator. He can, for instance, click with the computer mouse on bands or pole positions in the monitor image of the ion blocking pattern, transfer these spatial coordinates to an evaluation computer and have indexing done by the computer program.

A further task of the presented invention is to provide an automated, computer-controlled device, based on ion blocking patterns, for texture measurement and evaluation at high spatial resolution and high speed as well as to provide the related technique. This task is solved in the invention by means of a device with the features as stated in claim 4.

In that the device comprises preferentially means for automatic detection and localization of bands in ion blocking patterns, for automatic indexing of bands which are detected and located in ion blocking patterns, for calculating the related grain orientations, for recording the calculated grain orientations along with the spatial coordinates of the related sample locations, for calculating the crystal texture as well as orientation distribution maps and microstructure parameters derived from the calculated grain orientations, for determining the lattice structures of the crystallites in the specimen from the ion blocking pattern, as well as for discriminating or identifying the phases in the specimen on the basis of the determined lattice structures, an automated, computer-controlled measurement and evaluation of texture is enabled at high spatial resolution and speed of measurement. The device can optionally also comprise only a few of the stated means to automate the corresponding steps of evaluation, while the remaining steps of evaluation can still be carried out by the operator so far as wished-for.

The relative positioning of the ion probe and the specimen can be controlled digitally by a mechanical translation of the specimen with respect to the ion probe and/or by deflection of the ion probe with respect to the specimen.

It is preferred that the imaging ion detector comprises a first microchannel plate (MCP), a transparent phosphor screen and a multi-array sensor (for instance a CCD or CMOS camera chip). Particularly preferred is an imaging ion detector that comprises in addition a second microchannel plate which has a chevron arrangement with respect to the first microchannel plate. By this means neutral particles and ions are prevented from reaching and damaging the scintillator respectively the phosphor screen. It is preferred that the entrance of the first microchannel plate is placed on a potential in the 100 V range relative to the specimen-mounting device. By this means ion-released electrons are prevented from reaching the detector. The negative potential is preferentially in the range between 50 V and 500 V and particularly preferred in the range between 200 V and 300 V.

It is preferred that the diameter of the ion probe is smaller than the size of the crystallites in the specimen. By this means it is achieved that the ion blocking pattern are recorded from individual grains and so the single orientations of the crystallites can be determined. For the study of fine-crystalline nano-materials and of metals after plastic deformation of more than 95%, the ion probe is focused in a diameter down to 1 nanometer. If the crystallites under investigation are larger, focusing is only necessary to a larger probe diameter down to a few 10 nanometers in diameter.

The technique of this invention comprises by preference the automated detection and localization of bands in ion blocking patterns, the automated indexing of bands detected and located in ion blocking patterns, the recording of calculated grain orientations along with the spatial coordinates of the related sample locations, the calculation of crystallographic texture as well as of orientation distribution maps and microstructure parameters derived from the grain orientations, the determination of lattice structures of at least one of the crystallites in the specimen from the ion blocking patterns as well as the discrimination and identification of phases in the specimen based on the determined lattice structures.

If the crystal lattice (lattice type, lattice centering, lattice constants) of the phases present in the specimen are sufficiently different, they can be discriminated from each other respectively can be determined by means of the geometrical arrangement and intensities of the bands in the ion blocking pattern.

Detection, localization and indexing of the bands in the ion blocking patterns as well as the calculation of the grain orientations can be performed optionally either on-line, i.e. simultaneously with recording the ion blocking patterns, or off-line, i.e. afterwards based on the cached ion blocking patterns.

It is preferred that the automatic detection and localization of a band in an ion blocking pattern comprises the execution of a Radon transformation of the ion blocking pattern. By this means the recognition of line shaped bands is reduced to the detection of extremes in the Radon transform.

It is preferred that the technique of this invention comprises furthermore the correction of the background in an ion blocking pattern by means of normalization on or subtraction of a flat image in real space and/or in Radon space. By performing the correction in Radon space it is achieved that artifacts are corrected as well that can arise during pattern transformation. The flat image can be obtained by recording a large number of ion blocking patterns, calculation the flat image as average of the ion blocking patterns and filtering the flat image.

It is preferred that automatic detection and localization of a band in an ion blocking pattern comprises the interrogation of the profile along a straight line and the exclusion of those straight lines from Radon transformation which only cross a band in sections. By this means the removal of interfering ghost peaks and sharpening of the peaks in Radon space, and thus reliable band localization are achieved.

It is particularly preferred to interrogate a profile and to exclude straight lines as follows. The intensities of successive pixels of the straight line are evaluated and compared with the average background in the already background-corrected ion blocking pattern. In a first step a smoothed intensity profile along the straight line is computed by calculating a sliding average over a preselected number of pixels which is preferentially in the range of 5 to 10. The following exclusion criteria or some subset of those criteria are applied: i) The intensity variation of the smoothed intensity profile in successive pixels is greater than a preselected value which is by preference between 10% to 30% and with particular preference 20%. ii) The length of the plateau in the smoothed intensity profile is shorter than a preselected portion of the length of the straight line that is by preference 75% to 95% and by particular preference 85%. In this case the straight line is not running within a band. iii) The average intensity of the plateau in the smoothed intensity profile is greater than a preselected fraction of the average background of the pattern that is by preference 75% to 95% and by particular preference 85%. Since the bands have a lower intensity than the average background, as a consequence of the blocking effect, this straight line is not running within a band, but is crossing the band at an angle of typically >10°. In order to allow for complex ion blocking patterns, in particular in case of low crystal symmetry, the preselected fraction of the average pattern background has to be experimentally adjusted in the individual case. Straight lines which fulfill one or several of the applied exclusion criteria are not Radon transformed. By this procedure an exceptionally reliable removal of interfering ghost peaks and an exceptionally strong sharpening of the peaks in Radon space, and thus exceptionally reliable band localization are achieved.

It is preferred that automatic indexing of a band that has been detected and localized in an ion blocking pattern comprises the determination of the positions of poles, i.e. section points of crystallographic zone axes in the ion blocking pattern. This is carried out by means of a convolution filter which is adjusted to the shape of dark “patches” at the crossing points of bands. This information is utilized, in addition to the information from the band positions, for indexing and improves reliability of orientation determination.

Further preferred embodiments of the invention follow from the remaining characteristics as mentioned in the subsidiary claims.

The imaging ion detector of the invention solves the afore mentioned problems which might arise when detectors are used that are made for the automated recording of backscatter Kikuchi patterns.

By means of the microchannel plates in chevron arrangement, the neutral particles and ions are hindered to reach and damage the scintillator respectively the fluorescence screen. The ion blocking pattern is transformed in an electron pattern. Furthermore, by raising the potential at the entrance side of the first microchannel plate to about 100 V negative with respect to the earthed specimen, ion-released electrons are prevented from entering the detector. They escape from the bulk—like secondary electrons—with low energies of typically 50 eV and are not accelerated. They would release secondary electrons when entering the first microchannel plate and give rise of a stronger background without information about the IBP. The pattern forming ions are not deflected from their trajectory by the weak electrostatic retarding field in front of the microchannel plates, because they have a high energy (typically 30 to 100 keV). Hence the pattern is not distorted. The second microchannel plate is placed at a gap of a few millimeter close behind the first microchannel plate such that no blur is induced in the pattern due to the exit cone of the electrons emerging from the first plate. The channels of both plates are tilted by about 10° against each other. This arrangement avoids the straight pass of high-energy ions and neutral particles to the phosphor screen.

In the applications of ion blocking patterns as presented in the literature these measures need not be taken. When ion blocking patterns are recorded on photographic plates, the ion-released electrons are not interfering since they cannot blacken the emulsion. Several copy steps in the darkroom have equalized the strong background.

Digital beam scan or mechanical scanning with the specimen stage as well as recording, reading and storing of patterns is state of the art. The simplest embodiment of this invention is possible with a commercial scanning ion microscope because the deflection unit and a focused ion probe are already available. The patent by T. Ishitani and O. Takeshi [Crystal-orientation observing apparatus utilizing converged ion beam. JP 1991-289551] is focused on choosing the optimized ion species from a Liquid Metal Ion Source (LMIS, FIB) for reducing beam damage in the sample. In imaging mode of this ion scanning microscope crystal orientation images (named scanning ion microscopy images COSIM) are described. The grain contrast, however, cannot provide qualitative nor quantitative information about the crystallographic orientations. For the acquisition of ion blocking patterns, a video camera, optionally intensified by a channel plate, is placed outside the specimen chamber and directed to a phosphor screen inside the chamber. Orientation determination of a grain is suggested by (visual) comparison of the appearance of an acquired ion blocking pattern with a simulated one. Neither the locations of individual bands nor of individual poles are determined for indexing and orientation calculation. This embodiment is therefore not suited for the determination of a large number of crystallographic orientations, as is necessary for texture analysis and the characterization of a polycrystalline specimen, for several reasons: i) the phosphor screen will not withstand a prolonged exposure to high-energy ions forming the pattern; ii) interpretation of ion blocking patterns is carried out interactively by the operator by (visual) comparison with a simulated pattern rather than automatically. This procedure is suitable for a very limited number of crystallites only. iii) Comparison with a simulated pattern is in practice limited to high-symmetry lattices only, in particular to cubic symmetry, because of the increasingly complexity patterns with decreasing lattice symmetry. iv) The technique is thus susceptible to obtaining false results. In summary it is not adequate for texture analysis.

Since speed of indexing the patterns depends on the complexity of the actual pattern and hence on the orientation, the scan generator of the microscope is by preference not used for online orientation determination. This scan generator is optimized for the usual imaging mode and shifts the beam in constant time intervals from one sample point to the next (“constant dwell time”). Digital beam scan respectively control of the specimen stage, however, is controlled externally by the evaluation computer as “master”, in synchrony with reading the patterns. The deflection unit of the scanning microscope acts as “slave”.

If pattern evaluation is done off-line, the patterns can be recorded and read at constant speed. In this case, scanning can be carried out in principle by means of the beam deflection unit of the scanning microscope that is optimized for conventional imaging mode. Synchronization in time of measurement and evaluation is here not necessary.

Background in the pattern can be determined and corrected in various ways.

Prior to measurement, a flat image—i.e. a pattern with lowest possible details of an ion blocking pattern—can be acquired. For this purpose either a pattern is acquired by integration over a large area of the specimen so that an average over a great many of patterns from differently oriented crystals is obtained. The structure of the individual ion blocking patterns is thus balanced out. An alternative is to defocus the primaries so far that the beam aperture is significantly larger than the critical angle of ion blocking. The band details disappear in this flat image so that essentially the background information is left. The flat image serves for subtracting the background from the pattern to be indexed or for normalizing the pattern on the flat image.

A flat image can also be generated analytically by filtering the patterns with median or Sobel filters. This is state of the art. For ion blocking patterns, however, the filters have to be adjusted to the particular structure of bands and poles in the patterns.

During off-line evaluation of measured sequences a flat image can be constructed afterwards as an average by integration of a number (typical are several hundreds) of patterns of the sequence.

It can be subjected to additional filtering. By means of this flat image background correction can be done for every pattern to be evaluated by normalization or subtraction.

Detection of bands in ion blocking patterns can be carried out fully automatically with a computer program by applying edge detection algorithms, for instance the Burns algorithm or the Radon or Hough transformation and convolution filters. The bands are only a few radian minutes broad and virtually straight lines as a consequence of the small wavelength of corpuscular radiation as compared to the lattice spacings. Poles in the ion blocking patterns are alternatively detected by applying convolution filters or special search algorithms. The computer program utilizes the known angular relations between lattice planes and directions in the crystal.

For band localization in backscatter Kikuchi patterns a modified Hough transformation is commonly applied according to the state of the art. In compliance with this invention the Radon transformation is used as well, apart from the Hough transformation, for localization of bands in ion blocking patterns.

The fully automated measurement of band positions is carried out not in the real ion blocking pattern but after a Radon transformation of the gray-tone image f(x, y) [J. Radon: Über die Bestimmung von Funktionen durch ihre Integralwerte längs gewisser Mannigfaltigkeiten. Ber. Sächs. Akad. Wiss. Leipzig 69 (1917) 262-267]:

$$R ( ρ , φ ) = {\int }_{- ∞}^{∞} {\int }_{- ∞}^{∞} f ( x , y ) \cdot δ ( ρ - x \cdot cos φ - y \cdot sin φ ) d x d y$$

It is based on the normal form of a straight line:

ρ=x·cos φ+y·sin φ

ρ is the distance of the straight line from origin, φ is the slope angle to the x axis, δ the Dirac delta function. A straight line {x, y} as the image motif is thus mapped in a single point (ρ,φ) in Radon space with the Cartesian coordinate axes ρ−φ. The bands, as superpositions of enclosed and of crossing lines, result in narrow, butterfly-shaped intensity distributions. These Radon peaks can be localized significantly more easily than band shaped motifs. Special convolution filters (“butterfly filters”) or a linear Fourier transformation are applied for finding the peaks; the algorithms after adjusting the filter are state of the art. After back-transformation the width, the location as well as the intensity profile of the band under consideration are known. If at least three bands of a pattern have been determined, indexing can be done. In practice, however, significantly more bands are required to get a unique and reliable solution.

A simple special case of the general Radon transform is the Hough transform [P. V. C. Hough: A method and means for recognizing complex patterns. U.S. Pat. No. 3,069,654 (1962)]. It is used in image processing almost solely for localization of sharp lines and straight edges in binary images. A point in the image is mapped in Hough space with Cartesian coordinate axes ρ−φ in a sinusoid curve

ρ(φ)=x·cos φ+y·sin φ

that represents all possible reference lines through this image point.

The sinusoid curve which is formed by the transformation of an image point in the pattern is attributed uniformly the intensity of this image point along the curve shape. Finally, the sinusoid curves of all image points are superposed (“accumulated”). For the points on a straight line in the pattern these curves in Hough space intersect in exactly one point and form a maximum by accumulation. It relates to the summed intensities of collinear image points. Neighboring reference lines within a band and the bundle of reference lines that are inclined at small angles between each other form butterfly-shaped peaks. A band with a rectangular intensity profile in the pattern is thus mapped in a butterfly-shaped intensity distribution, very similar as with a Radon transformation, by transformation of the enclosed lines and the straight lines which cross the band.

A particular advantage of the Radon transformation over the Hough transformation is the possibility to process the whole motif—in case of ion blocking patterns are these the straight lines forming and crossing the bands—before transformation in the Radon space. This possibility is used according to this invention to interrogate the profile along the straight lines. By this means reference lines are excluded from transformation that are only crossing rather than running in the bands. Only straight lines that are predominantly running in the band are transformed in the Radon space. This results in a removal of interfering ghost peaks and sharpening of the peaks in Radon space, and hence to a more reliable band localization.

Background correction can be carried out not only in the pattern but as well in Radon space. For this purpose the flat image is transformed in a first step. The transformed pattern is then normalized on the transformed flat image, i.e. is divided pixel by pixel by the transformed flat image. By this means artifacts are also corrected that had been induced by the pattern transformation.

Poles, that are section points of crystallographic zone axes in the ion blocking patterns, are utilized as well for indexing the patterns. Their positions in digitized patterns are determined with a convolution filter which is adjusted to the shape of dark “patches” at the crossing points of bands. This information is used in addition to the information from the position of bands for indexing and increases reliability of orientation determination.

The center lines of the bands correspond to section lines of low indexed lattice planes of the crystallite under the primary beam that have been imaginarily stretched out to reach the phosphor screen. So the point of impact of the primary beam corresponds to the center of a gnomonic projection of the crystal lattice on the flat phosphor screen. The distortion by gnomonic projection is corrected analytically in the program. The angles between center lines of bands are then equal to angles between low-index lattice planes in the crystal; the angles between poles are angles between low-index directions in the crystal. The measured angles are checked with angles known from the crystallography of the specimen so that a consistent indexing of the detected bands is achieved. Thereof the orientation of the crystallite producing the ion blocking pattern is computed by means of known formulae of crystallography. (These crystallographic calculations are state of the art.)

The calculation of texture parameters (for instance, orientation density function ODF, pole figures, crystallographic misorientations, Sigma grain boundaries, orientation correlation functions) and graphical representations of orientation maps in pseudo-colors (“Orientation Microscopy”, orientation maps) from the data set of a measuring sequence is state of the art.

In the following the invention is exemplified by an embodiment and a related drawing.

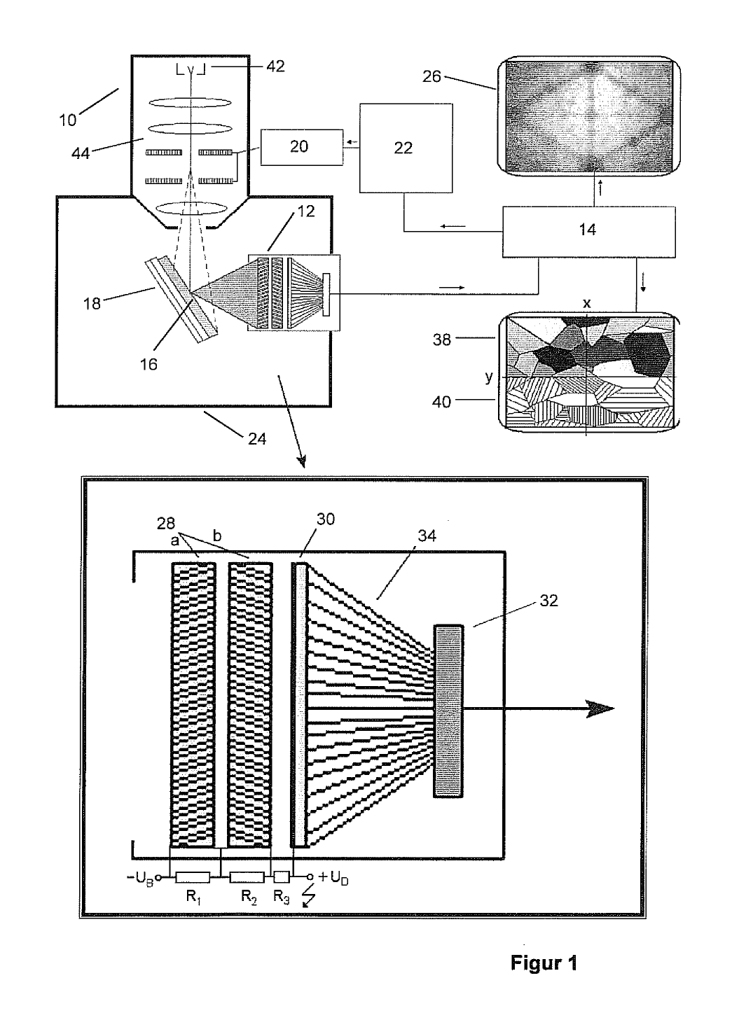

An embodiment of the invention is schematically represented in FIG. 1. In this example the device comprises a scanning ion microscope 10, an open microchannel image intensifier camera as imaging ion detector 12 and a control/evaluation computer 14. The specimen 16 is placed on the specimen stage 18 of the scanning ion microscope 10. The control of the primary ion beam can optionally be done by means of the scanning unit 20 of the microscope (in particular for off-line evaluation) or by means of an external beam control 22 (digital beam scan). The operator can as well position the beam interactively on the specimen surface. The necessary ports for the external beam control 22 are available on scanning ion microscopes ex factory or can be ordered as an option.

The imaging ion detector 12 is mounted on the specimen chamber 24 of the scanning ion microscope 10 with viewing direction to the specimen surface. The specimen 16 is typically tilted by 45° out of the horizontal to the primary beam, the detector 12 views typically at 45° on the specimen 16. These angles are not critical, because the ion blocking pattern 26 is emitted in a large angular cone. The conversion of the ion blocking pattern 26—whose emission cone is marked in gray in FIG. 1—in an electron image takes place at the entrance of the ions in the microchannel plate 28. The ions release electrons from the walls of the microchannels. They are accelerated in the voltage gradient in the direction to the phosphor screen 30. The additional electron multiplication by the generation of secondary electrons in the channels (image intensification) is desirable, but not strictly necessary for function. A fraction of the ions that have been backscattered from the crystal lattice can change or loose their charge as a result of charge transfer effects in the specimen 16 or on the way to the detector 12, without a noticeable change of their direction of path. These particles thus still bear information of the ion blocking pattern 26. They can—irrespective of their charge—be used for imaging with this ion detector 12, because they as well release electrons when entering the channels of the microchannel plate 28. The working voltage UD of the ion detector 12 need not be changed for this purpose. The phosphor screen 30 is on positive high voltage. In the channels a voltage gradient is formed where the primary and secondary electrons are accelerated in the direction to the phosphor screen 30. The resistors R1, R2 and R3 are potential dividers with values in the Mega Ohm range.

For image signal optimization the entrance side of the microchannel plate 28 is put on a negative potential in the 100 Volt range rather than on ground potential. This retarding voltage UB avoids low-energy electrons—released by ion impact from the specimen surface or from surfaces in the specimen chamber 24—to reach the ion detector 12 and to increase background in the ion blocking pattern 12.

It is of advantage to use a chevron-type microchannel plate 28—in FIG. 1 schematically represented by an angled pathway of the microchannels—since it suppresses the direct pass of high-energy ions and neutral particles to the phosphor screen 30, which otherwise might result in damaging the phosphor screen 30.

The optical coupling of the sensor 32 (for instance a CCD or CMOS camera chip) to the phosphor screen 30 can be made by means of a (tapered) fiber optic 34 or by means of a light-optical lens. The exposition of the sensor 32 can also be done directly, without the light-optical indirect way through the phosphor screen 30, by the electrons that emerge from the image converter.

A typical ion blocking pattern 26 is displayed on the monitor top right. The monitor image on the bottom right schematically shows in the upper half an orientation distribution map 38 which is constructed from the orientation data in the individual scan points, and in the lower half schematically shows a conventional image 40 of the polycrystalline microstructure.

Instead of the combination of a microchannel plate 28 and a video camera as imaging area detector 12, as described above, other imaging ion detectors 12 are also possible.

A possible embodiment is a combination of a scintillator and a light-sensitive 2D sensor array. At present slices in particular of single crystals (garnets) of YAG:Ce and of YAP:Ce may serve as scintillators, but other scintillator materials are also available (www.crytur.com). Because of the high refractive index of garnet single crystals, they must be coupled fiber-optically to the sensor array to achieve a high light transmission. The long-term stability of garnet scintillators against ion impact has still to be checked. To prevent from possible fluorescence activation by electrons—that are released from the specimen by ions—the front side of the scintillators has to be put on a negative potential of about 100 V to ground if necessary. As light-sensitive 2D sensor arrays CCD or CMOS sensors, for instance, come at present into consideration.

In the future direct recording of ion blocking patterns might also be possible by means of a two-dimensional imaging solid-state detector. So far only a one-dimensional (i.e. linear) detector has been realized [M. P. Sinha and M. V. Wadsworth: Direct detection of low-energy particles using metal oxide semiconductor circuitry. U.S. Pat. No. 6,576,899 B2 (2003)]. This type of detector can operate under moderate high vacuum up to atmospheric pressure as well, and is not damaged by ion impact

1-22. (canceled)

23. A crystal orientation measurement device comprising:
an ion source (42);
an ion focusing device for focusing of ions emitted from said ion source in an ion probe;
a specimen support (18) for supporting a crystalline or polycrystalline specimen; and
an imaging ion detector (12) for the acquisition of at least one ion blocking pattern (26) in digital form, said imaging ion detector comprising a first microchannel plate (28a), a transparent phosphor screen (30) and a multi-array sensor (32);
wherein said crystal orientation measurement device is constructed to direct said ion probe successively on a great number of selected locations on said specimen and in doing so said ion blocking pattern is acquired in digital form on each of the selected locations by means of said imaging ion detector.

24. The crystal orientation measurement device according to claim 23, wherein said crystal orientation measurement device is constructed to fully automatically scan said specimen point by point with said ion probe.

25. The crystal orientation measurement device according to claim 23 further comprising:
means for interactive representation of one of the digitally recorded ion blocking patterns to enable the operator to detect and localize the bands in at least one ion blocking pattern;
means for the automatic detection and localization of at least one band in at least one ion blocking pattern;
means for automated indexing of at least one band which has been detected and localized in at least one ion blocking pattern and for calculation of at least one related crystal orientation;
means to store at least one calculated grain orientation along with the location coordinate of the related specimen locus;
means to calculate the crystal texture as well as orientation distribution maps and derived microstructure parameters from at least one calculated grain orientation;
means to determine at least one lattice structure of at least on crystallite contained in the specimen from at least one ion blocking pattern; and
means to discriminate or determine at least one of the phases present in the specimen based on at least one of the determined crystal structures.

26. The crystal orientation measurement device according to claim 23, wherein relative positioning of said ion probe and said specimen is digitally controlled by a mechanical translation of said specimen with respect to said ion probe by deflecting said ion probe with respect to said specimen.

27. The crystal orientation measurement device according to claim 23, wherein said imaging ion detector further comprising a second microchannel plate having a chevron-type arrangement with respect to said first microchannel plate.

28. The crystal orientation measurement device according to claim 27, wherein an entrance side of said first microchannel plate is on a negative potential with respect to said specimen support whereby said negative potential is in the range between 50 V and 500 V.

29. The crystal orientation measurement device according to claim 28, wherein said negative potential is in the range between 200 V and 300 V.

30. The crystal orientation measurement device according to claim 28, wherein said imaging ion detector further comprising a phosphor screen on a positive potential, and a sensor optically coupled to said phosphor screen, said phosphor screen is positioned so as to receive electrons released from said ions from said first and second microchannel plates.

31. The crystal orientation measurement device according to claim 30, wherein said first and second microchannel plates have angled pathways so as to suppresses the direct pass of said ions and neutral particles to said phosphor screen.

32. The crystal orientation measurement device according to claim 30, wherein said optical coupling of said sensor to said phosphor screen is tapered fiber optics.

33. The crystal orientation measurement device according to claim 23, wherein a diameter of said ion probe is smaller than the size of crystallites in said specimen.

34. A method for crystal orientation measurement, said method comprising the steps of:
a) focusing of ions emitted from an ion source in an ion probe;
b) directing said ion probe at a crystalline or polycrystalline specimen supported by a specimen support; and
c) recording at least one ion blocking pattern in digital form by an imaging ion detector.

35. The method according to claim 34 further comprising step e) detecting and localizing automatically of at least one band in at least one said ion blocking pattern.

36. The method according to claim 35 further comprising step f) executing of a Radon transformation of at least one said ion blocking pattern.

37. The method according to claim 36 further comprising the steps of:
g) interrogating of a profile along at least one straight line; and
h) excluding said straight lines from Radon transformation which only run in parts in a band.

38. The method according to claim 37 further comprising the steps of:
i) indexing automatically of at least one said band detected and localized in step e), and determining of the location of at least one section point of a crystallographic zone axis in at least one said ion blocking pattern;
j) calculating of at least one related crystal orientation; and
k) storing of at least one said calculated crystal orientation along with location coordinates of a related specimen locus.

39. The method according to claim 38 further comprising the steps of:
l) calculating a crystal texture as well as orientation distribution maps and derived microstructure parameters from at least one of the said calculated crystal orientation of step j);
m) determining at least one lattice structure of at least one crystallites contained in said specimen from at least one said ion blocking pattern; and
n) identifying at least one phase present in said specimen based on at least one said determined lattice structure of step m).

40. The method according to claim 38 further comprising step o) correcting a background in at least one said ion blocking pattern by a flat image by normalization or subtraction in real space and/or in Radon space.

41. The method according to claim 40, wherein said step g) further comprising the steps of:
p) evaluating intensities of successive pixels along at least one straight line;
q) calculating a smoothed intensity profile along at least one straight line by sliding averaging over a preselected number of pixels; and
r) comparing the intensity with an averaged background in said background-corrected ion blocking pattern of step o), and the exclusion of straight lines of step h) comprises the application of at least one of the following steps to at least one of the straight lines:
s) evaluating whether a variation of intensity of said smoothed intensity profile along at least the one straight line is, in successive pixels, larger than a preselected value;
t) evaluating whether a length of a plateau in said smoothed intensity profile is shorter than a preselected fraction of a length of the at least one straight line; and/or
u) evaluating whether an average intensity of said plateau in said smoothed intensity profile is higher than a preselected fraction of said average pattern background,
whereby said at least one straight line is excluded from Radon transformation if at least one of the evaluations has a positive result.

42. The method according to claim 41 further comprising the steps of:
v) registering a number of said ion blocking patterns in digital form;
w) calculating a flat image as average of said ion blocking patterns; and
x) filtering of said flat image.
